(19) United States
(12) Patent Application Publication
(10) Pub. No.: US 2005/0241077 A1
(43) Pub. Date: Nov. 3, 2005

(54) Method of producing printed fabrics and the produced therefrom

(76) Inventor: Park Heoung Soo, Ansan City (KR)

Correspondence Address: GOTTLIEB RACKMAN & REISMAN PC, 270 MADISON AVENUE, 8TH FLOOR, NEW YORK, NY, 100160601, US

(21) Appl. No.: 10/833,981

(22) Filed: Apr. 28, 2004

(51) Int. Cl. C09B 67/00

(52) U.S. Cl. 8/478

(57) ABSTRACT

A raw fabric is bleached and coated with dyestuff in a base color. A coating, formed for example of an aqueous PEG solution, is also applied to portions of the fabric,. The fabric is heated and then washed causing some dyestuff from the coated fabric portions to be removed thereby leaving the respective portions of the fabric with a lighter shade. The coating is applied in a pattern, for example, a pattern that resembles or gives the fabric a Jacquard look.

### RELATED APPLICATIONS

None

### BACKGROUND OF THE INVENTION

1. Field of Invention

This invention pertains to a method of producing a printed fabric and more particularly, a process in which one side of the fabric is first coated with dyestuff and then a coating is applied in a decorative pattern or motif that affects the manner in which the dyestuff adheres to the fabric so that when the fabric is washed, some of the dyestuff is removed from the fabric.

2. Background of the Invention

There are many ways of producing decorative woven fabrics for clothing, furnishings and other uses. One popular way is to print patterns on fabrics. The most common fabric printing methods include silk screening and rotary printing. In many instances these methods are useful to produce printed fabrics with many different types of designs that have a high quality and are attractive esthetically.

However, these methods are not very effective in producing fabrics with very fine details. For example, designers and customers would like to have printed fabrics that have a knitted or so-called ‘Jacquard’ look. Neither the screening methods nor standard rotary printing methods are capable of producing fabric with patterns having sufficiently fine details to achieve this look.

### SUMMARY OF THE INVENTION

Conventionally, a printed fabric is made by bleaching a raw fabric and applying dyestuff to one surface, using a silk screening, a rotating print roller, etc. The fabric is then heated to set the dyestuff, washed and then inspected.

In order to make a fabric with motifs that have finer details, in the present invention, the conventional dyestuff is used to coat one side of a fabric so that the side has a ground or base color. Next, coating is applied. The fabric is then padded and heated. The fabric is then washed. During washing, dyestuff in the areas of the fabric covered by the coating is removed leaving a visible pattern on the fabric that has a lighter shade then the ground color.

Preferably, the dyestuff and the coating are applied using a rotary print roller.

The amount of dyestuff removed from the fabric during washing is dependent on the concentration of an active ingredient in the coating. A bigger concentration of this active ingredient (for example PEG) results in more dyestuff being washed off leaving the motif with a lighter shade.

The resulting fabric has a motif that is more precise and has finer details then fabrics made with the prior art methods. More specifically, the coating and the resulting motif can be selected to provide the fabric with a unique and intricate pattern that gives the fabric a knitted or Jacquard look.

### BRIEF DESCRIPTION OF THE DRAWINGS

FIG. 1 shows a flow chart of a conventional process for printing fabrics;

FIG. 2 shows a flow chart of process for printing fabrics in accordance with this invention;

FIGS. 3A-3D show a piece of fabric with a print applied in accordance with this invention.

### DETAILED DESCRIPTION OF THE INVENTION

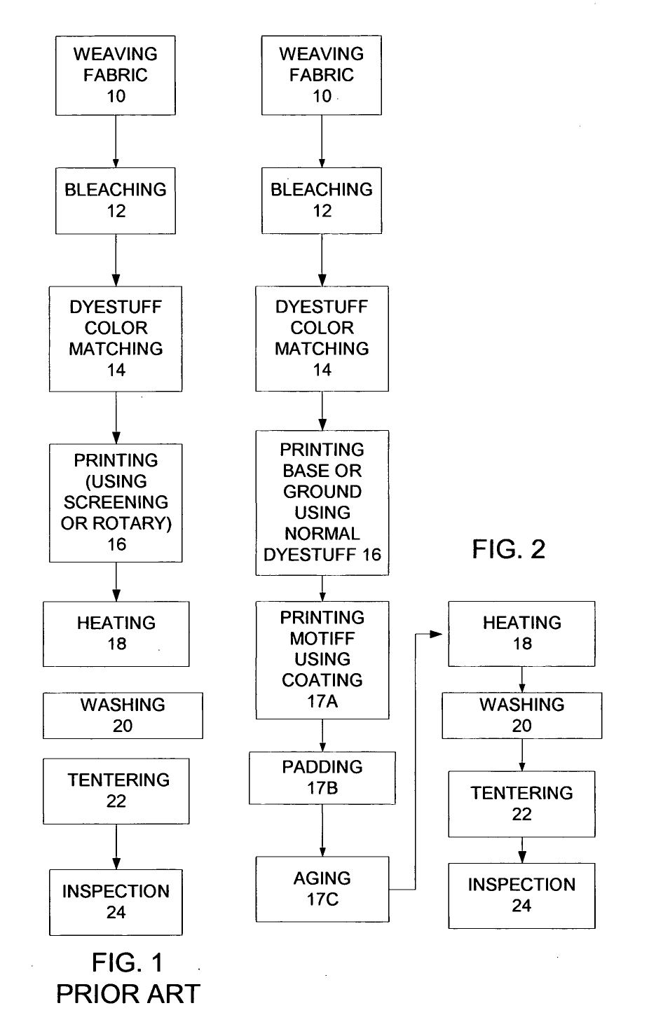

Referring first to FIG. 1, conventionally, a fabric is printed using the following process. First (step 10) the fabric is woven to obtain a raw or in grey fabric. Next, the woven fabric is bleached (step 12) so that it has a uniform, preferably white, color. In step 14 dyestuff is selected that is compatible with the fibers of the bleached fabric and that can be used to dye the woven fabric to the desired color.

Next, in step 16, the dyestuff is printed in a preselected pattern on the bleached fabric using either a silk screening technique or a rotary printer.

In step 18 the fabric is heated (and, optionally, pressed) to cause the dyestuff to adhere to the fabric fibers and to insure that the fabric is colorfast.

In step 20, the fabric is washed to remove excess dyestuff and other matter. Finally, the fabric is tentered to set its physical dimensions (step 22) and then inspected (step 24).

As discussed above, a problem with this process is that it cannot be used to make a fabric with a print having fine details. For example, the process cannot be used to make a fabric having a print imitating the look of a knit material (the so-called Jacquard look).

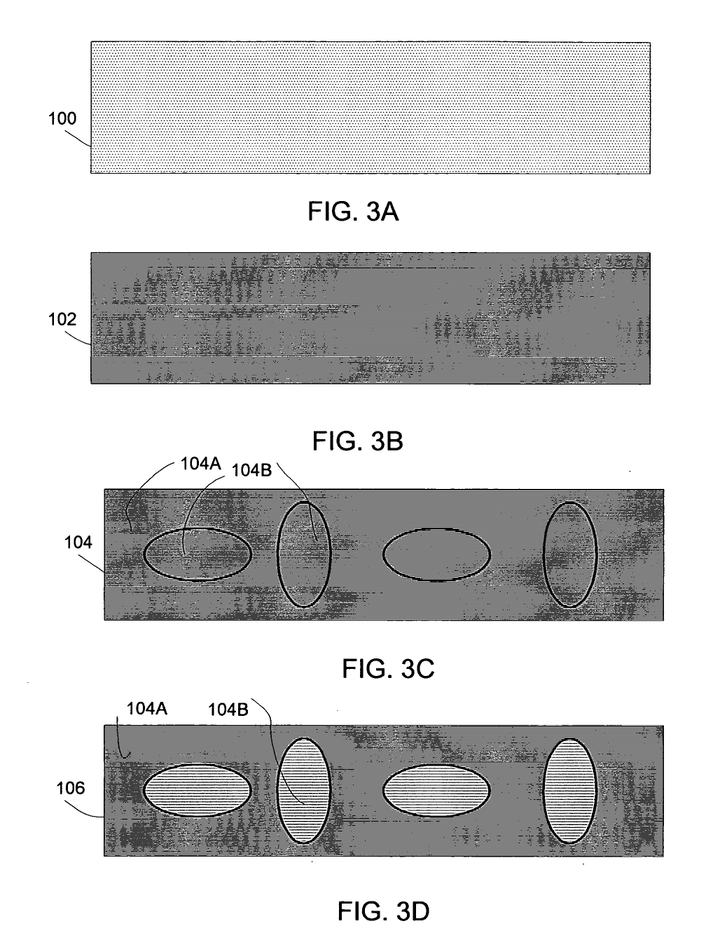

The present invention is now described in conjunction with FIGS. 2 and 3A-3D. The first three steps of the novel process are identical to the steps 10-14 in FIG. 1, with the fabric being woven in step 10 and bleached in step 12. FIG. 3A shows the bleached fabric 100. In step 14 dyestuff matching is performed.

In step 16 the dyestuff is applied to one side of the bleached fabric 100, preferably using a conventional rotary printing roller (not shown). The result is a base- or ground-color fabric 102 shown in FIG. 3B. This fabric has a uniform color with no distinctive design.

Next, in step 17A a coating is applied to the base-color fabric, again preferably using a printing roller. However, the printing roller is provided with a pattern defining on the fabric a selected motif. A printing machine with a roller suitable for this purpose is the DR-9000 printing machine made by the Daiyang Machinery Company of the Republic of Korea.

Thus, the fabric 104 from step 17A includes two different types of regions: region 104A with the base-color formed by the dyestuff, and regions 104B formed by the coating. It should be understood that in FIG. 3C (and 3D), regions 104B are shown as having a geometric elliptic shape for the sake of simplicity, however in actuality, these regions can have much more complicated shapes. The purpose of the coating is to inhibit or reduce the adherence of the dyestuff to the fabric fibers in the regions 104B.

The coating forming regions 104B may be composed of various materials and compositions. One preferred composition includes an aqueous PEG (polyethylene glycol) solution (available from Sanyo Chemical of Japan, Shell of the United States, etc.). A typical solution may consist of the following ingredients:

| | |
|---|---|
| PEG-400 | 67.3% |
| Petroleum | 15% |
| Urea | 12% |
| Sodium Chloride | 3% |
| Algin | 2.5% |
| Emulsifying agent | 0.2 % |

PEG-400 is an aqueous solution of PEG. The concentration of PEG in the PEG-400 aqueous solution may vary in accordance with the effects that are desired, as discussed below.

Importantly, the coating applied during step 17A is not visible on the fabric and regions 104B are shown in FIG. 3C only for illustrative purposes.

Once the coating is applied, in step 17B a padding step is performed during which the fabric is padded and pressed using a pressure nip or other means to insure that the dyestuff and the coating stay on the fabric. Next, in step 17C, the fabric is aged for about 40-50 minutes.

After aging, the standard process is resumed. In step 18 the fabric is heated to set the dyestuff. In step 20 the fabric is washed.

In the conventional process, the dyestuff is deposited on the fabric uniformly, and excess dyestuff is removed uniformly as well, during washing. Therefore, after printing, the appearance of the fabric remains unchanged. However, in the present invention, the presence of the coating changes the characteristics of the dyestuff and/or the fabric fibers. As a result, during washing a substantial amount of the dyestuff is removed from the regions 104B and therefore these regions are about 10-20% lighter than the regions 104A. In this manner, the pattern or motif defined by the coating during the printing step 17A becomes clearly visible, as shown in FIG. 3D. Depending on several factors, such as the color and contents of the dyestuff, and the composition of the coating, the regions 104B can be lighter by anywhere between 10-90% then the uncoated regions 104A.

After washing, the fabric 106 is tentered in step 22 and then inspected in step 24.

The resulting fabric has a pattern or motif that can have much finer details than the fabric obtained from conventional printing processes. Moreover, as discussed above, the difference in the shading between the ground color and the motif is easily but precisely controlled by changing the composition of the coating.

While the invention has been described with reference to several particular embodiments, it is to be understood that these embodiments are merely illustrative of the principles of the invention. For example, instead other coating compositions may be used, such as a sodium formaldehyde foxilate rongalite-c available from Hunan ZhongCheng Chemicals Co. Ltd. of Hunan, China. In addition, the sequence of the steps can be changed. For example, the coating could be applied before the printing of the base color. Alternatively, the coating step may be repeated with different solutions, thereby generating fabrics with multiple shadings. Accordingly, the embodiments described in particular should be considered as exemplary, not limiting, with respect to the following claims.

While the invention has been described with reference to several particular embodiments, it is to be understood that these embodiments are merely illustrative of the principles of the invention. Accordingly, the embodiments described in particular should be considered as exemplary, not limiting, with respect to the following claims.

1. A method of making a patterned fabric comprising:
applying dyestuff to a fabric to form a base-color fabric;
applying a coating on portions of the fabric, said coating defining a motif; and
removing dyestuff from said portions so that said portions have a lighter color than the remaining fabric.

2. The method of claim 1 wherein said coating is a PEG solution.

3. The method of claim 1 wherein said coating is an aqueous PEG solution.

4. The method of claim 1 wherein said coating is printed on said fabric.

5. The method of claim 1 wherein said coating is applied after said dyestuff.

6. The method of claim 1 wherein said coating is applied before said dyestuff.

7. A method of making a printed fabric comprising:
printing a coating on an undyed fabri;c
applying a dyestuff on said undyed fabric; and
washing the fabric to cause some dyestuff from portions of the fabric with coating to be removed to define a motif, said motif having a different color then the rest of the fabric.

8. The method of claim 7 wherein said dyestuff is printed on said fabric.

9. The method of claim 7 wherein said coating is a PEG Solution.

10. The method of claim 7 further comprising bleaching said fabric prior to the application of the dyestuff and coating.

11. The method of claim 7 further comprising padding said fabric after the printing of the coating.

12. The method of claim 7 further comprising heating the fabric after said printing of the coating.

13. The method of claim 7 further comprising tentering said fabric after washing.

14. The method of claim 7 wherein said printing is performed using a rotary printer.

15. The method of claim 7 wherein said dyestuff is applied using a rotary printer.

16. The method of claim 7 wherein the fabric is formed with said motif having a lighter shade than the rest of the fabric.

17. The method of claim 16 further comprising selecting the composition of the coating to determine the color of said motif.

18. The method of claim 7 wherein said motif is selected to provide a Jacquard look for said fabric.

19. A printed fabric comprising:
a surface covered with dyestuff defining having a base color; and
a portion formed on said surface said portion being defined by an invisible coating said portion being a shade that shade lighter than the base color.

20. The printed fabric of claim 19 wherein said coating is made from an aqueous PEG solution.

21. The printed fabric of claim 19 wherein said portion is shaped to form a motif on said surface that provides a Jacquard look for the fabric.
